(19) United States
(12) Patent Application Publication
(10) Pub. No.: US 2012/0290810 A1
(43) Pub. Date: Nov. 15, 2012

(54) Memory Access Latency Metering

(76) Inventors: Jean-Jacques Lecler, Cagnes-sur-Mer (FR); Philippe Boucard, Le Chesnay (FR); Jonah Proujansky-Bell, Alviso, CA (US)

(21) Appl. No.: 13/450,342

(22) Filed: Apr. 18, 2012

Related U.S. Application Data
(60) Provisional application No. 61/476,674, filed on Apr. 18, 2011.

(51) Int. Cl. G06F 12/02

(52) U.S. Cl. 711/167; 711/E12.002

(57) ABSTRACT

Memory transactions that are issued just in time have deterministic response delay. By measuring an actual delay and comparing it to an expected delay a memory scheduler can determine whether it is issuing transaction requests too early and can thereby automatically adapt the issue of transaction requests by delaying future transaction requests to be just in time.

### CROSS-REFERENCE TO RELATED APPLICATION

This application claims priority to pending U.S. Provisional Application No. 61/476,674, entitled “Memory Access Latency Metering for Network Interconnect,” filed on Apr. 18, 2011, the entire contents of which are incorporated herein by reference.

### TECHNICAL FIELD

The disclosed subject matter is in the field of memory controls, such as Dynamic Random-access Memory (DRAM) controllers in system-on-chip (SoC) semiconductor devices.

### BACKGROUND

In order to access a DRAM memory, a system has to issue different commands for activities such as closing a page, opening a page, reading, and write writing. DRAM devices have strong constraints on the minimum delays between those events, dictated by the physics of its bit-arrays, sense-amplifiers, and shared tri-state data wires. A system accessing a DRAM should: (1) choose the order in which the transactions are performed, and (2) make sure that delay constraints are followed since a failure to do so could lead to data loss or even damage the hardware system.

In a conventional design, transaction order and delay constraints are often handled in different hardware sub-systems. As shown in FIG. 1, memory scheduler 101 receives transaction requests. These occur at unpredictable times. Often memory scheduler 101 has more than one request pending in a pool of transaction requests. The same set of requests may monopolize memory 104 (e.g., DRAM) for significantly different durations depending on the order in which the transaction requests are executed by memory controller 102, and thus impact the throughput of memory 104. Memory scheduler 101 typically handles multiple transaction requests through arbitration. The way that memory scheduler 101 performs this arbitration should take into account: (a) the efficiency of memory 104 (a correct choice allows more transactions to be done in a given time period); (b) the functional and protocol constraints, such as read-after-write and write-after-read sequences in a given memory cell; and (c) the quality of service (QoS) expected by the different initiators of transaction requests.

In some conventional designs, the strict compliance with delay constraints is handled by memory controller 102. Memory controller 102 is given a stream of transaction requests from memory scheduler 101, and translates those transaction requests into commands to memory 104 through physical layer (PHY) 103. PHY 103 performs no transformation, but adds a constant amount of delay to all transactions.

The memory commands to fulfill the requests are issued in the order dictated by memory scheduler 101. It is not possible for memory scheduler 101 to recall or cancel a posted transaction request or reorder transaction requests.

In order to avoid backpressure in the memory system, most memory controllers have a First In, First Out (FIFO) queue 105 for “elastic buffering,” often referred to as a “command queue.” When queue 105 is full, memory controller 102 gives back-pressure to the memory system. When queue 105 is empty, memory controller 102 may directly issue the command to fulfill a request as soon as it is received from memory scheduler 101. Once a transaction request is posted by memory scheduler 101 to memory controller 102, memory scheduler 101 has no signal from memory controller 102 of whether the transaction request is directly issued as a command to memory 104 or whether it is buffered in queue 105.

Ideally, memory scheduler 101 should refrain from issuing any transaction request until just before the absence of a request would cause memory controller 102 to fall idle. If a transaction request is committed too early then a new candidate transaction request that would have been preferred might enter the scheduler pool after the request is made. By delaying the decision of which request to choose from the pool and post to memory controller 102, memory scheduler 101 increases the probability of issuing commands that make full utilization of Double Data Rate (DDR) or have a better QoS properties. This is done without any consequence on the performance of memory controller 102. This is known as constructive waiting.

This prediction of the behavior of the memory controller by the memory scheduler cannot be entirely accurate for two reasons: (a) the designer of the memory scheduler might not have a complete model of the behavior of the memory controller and even if she did, the calculation would be unreasonably complex to be performed with logic that could close timing, and (b) some events, such as memory refresh, are spontaneously initiated by the memory controller and cannot be anticipated by the memory scheduler. The fact that the memory scheduler does not predict the memory controller behavior accurately leads to a drift of the filling level of the elastic buffer.

### SUMMARY

Memory transactions that are issued just in time have deterministic response delay. By measuring an actual delay and comparing it to an expected delay, a memory scheduler can determine whether it is issuing transaction requests too early and can automatically adapt the issue of transaction requests by delaying future transaction requests to be just in time. The disclosed memory access latency metering ensures that memory commands are scheduled to be issued just in time for full utilization of a memory controller, PHY, and memory chip for memory access.

In some implementations, a memory scheduler comprises: a latency objective value; a timer that measures a length of time between a transaction request and a corresponding response to the transaction request; logic configured to compare the length of time to the latency objective value, determine that the length of time is greater than the latency objective value, and delay a following transaction request.

In some implementations, a method of optimizing memory throughput comprises: measuring a length of time from a transaction request to a reception of a response; comparing the length of time to a latency objective value; determining that the length of time is greater than the latency objective value; and delaying a following transaction request.

### BRIEF DESCRIPTION OF THE DRAWINGS

FIG. 1 is a block diagram of a state of the art memory subsystem.

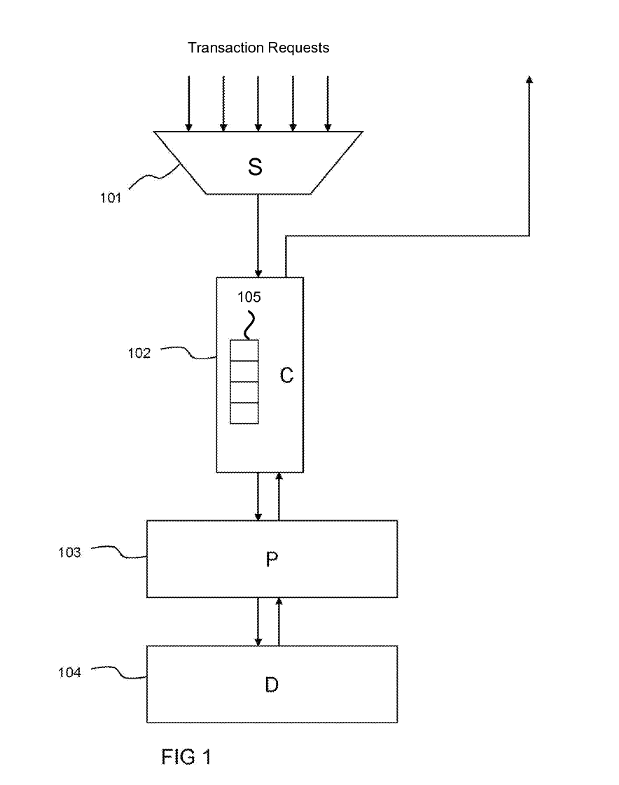

FIG. 2 is a block diagram of a memory subsystem including a latency time meter.

FIG. 3 shows a timeline of events and a latency objective.

### DETAILED DESCRIPTION

The pipeline delay through the memory controller and PHY is approximately constant. An interesting consequence of constructive waiting is that if the memory scheduler commits transaction requests just in time then the latency experienced by the memory scheduler between the posting of the transaction request and the reception of the response (e.g., read data coming back from the memory) is approximately deterministic.

In order to anticipate, for each transaction request, whether or not the request would be just in time to keep the controller busy, the memory scheduler has a model of the expected latency. This is referred to as the latency objective for transactions. If the memory scheduler observes that a transaction took a longer length of time to execute than the latency objective value, this indicates that the memory controller delayed the transaction in its queue, and thus the memory scheduler had delivered it to the memory controller earlier than necessary.

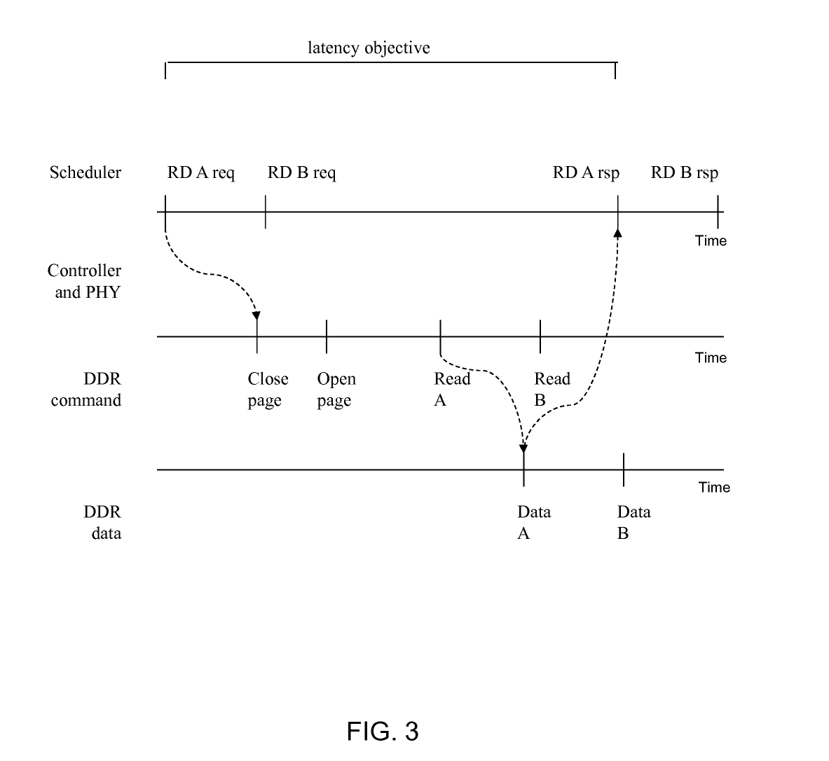

A timeline for two consecutive read transaction requests (RD A and RD B) is shown in FIG. 3. RD A is a memory bank miss and causes a previously used page of memory to be closed and a desired page of memory to be opened. RD B is a hit in the already-opened desired memory bank. This information is known by the memory scheduler and accounted for in the expected time of a response. After the desired page is open, a Read command for transaction RD A is issued from the memory controller to the memory chip, immediately followed by a Read B command for the RD B transaction. Response data is received some deterministic time later for RD A, followed immediately by the data for RD B.

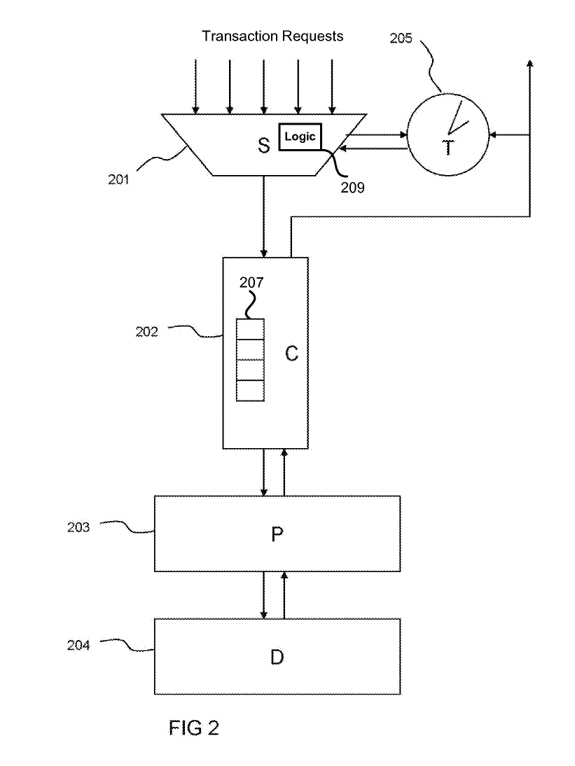

The disclosed memory subsystem utilizes the deterministic latency property of just-in-time scheduling. A memory access latency metering system is shown in FIG. 2. The system uses timer 205 to measure the latencies of transactions. Latency is the time duration of time between when the transaction request is sent, and the response is received at the interface between the memory scheduler 201 and the memory controller 202. The latency comprises the time for the request to pass from memory scheduler 201 through the memory controller 202, PHY 203, to memory 204 and the response to be returned from memory 204 through PHY 203 and through memory controller 202 to the memory scheduler 201. Logic 209 compares the measured latency of each transaction to an expected latency and thereby detects whether the memory scheduler 201 submits the request to command queue 207 in memory controller 202 earlier than necessary and by how much. Logic 209 located within memory scheduler 201 then delays the issuing of a successive request from memory scheduler 201 to memory controller 202. By so delaying, memory scheduler 201 accommodates late arriving transaction request candidates that are more suitable for processing. A request candidate is more suitable if, for example, it would use a more available resource in the memory such as an open page rather than a closed page in memory (e.g., DRAM). As a result, the memory system maximizes utilization of memory 204. Using memory latency metering has the further benefit that it is insensitive to the depth of queue 107 (elastic buffer) within memory controller 202. Therefore, memory controller 202 can be configured with a small queue 107 and thereby save die area in the memory chip.

In one embodiment, a software programmable register in memory scheduler 201 stores the expected latency of a read transaction. This latency takes into account delays that occur in memory controller 202, PHY 203 and memory 204 components. As memory scheduler 201 commits read transactions to memory controller 202, logic 209 in memory scheduler 201 computes the time at which response data words are expected to be received by memory control 102. If, at the expected time, read data has not been received, memory scheduler 201 delays issuing another transaction request for an amount of time equal to the difference between the actual time and the expected time of the reception of the read response.

In another embodiment, the expected latency is calculated by logic 209 in the memory scheduler 201. If the measured latency is less than the expected latency then the expected latency is changed to the value of the measured latency. In this way, memory scheduler 201 is trained to know the minimum latency through the controller 202, PHY 203, and memory 204. That minimum latency is deterministic.

What is claimed is:

1. A memory scheduler comprising:
a latency objective value;
a timer that measures a length of time between a memory transaction request and a corresponding response to the memory transaction request;
logic configured to compare the length of time to the latency objective value, determine that the length of time is greater than the latency objective value, and delay a following transaction request.

2. The memory scheduler of claim 1 further comprising logic to delay the decision of the immediately successive transaction request.

3. The scheduler of claim 1 wherein the latency objective value is stored in a writeable register.

4. The memory scheduler of claim 1 wherein the latency objective value changes based on the length of time.

5. A method of optimizing memory throughput, comprising:
measuring a length of time from a transaction request to a reception of a response to the transaction request;
comparing the length of time to a latency objective value;
determining that the length of time is greater than the latency objective value; and
delaying a following transaction request.

6. The method of claim 5 further comprising delaying a decision of the following transaction request.

7. The method of claim 5 further comprising changing the latency objective value based on the length of time.

8. The method of claim 5, wherein the amount of delay of the of the following transaction request is a function of the difference between the length of time and the latency objective value.

9. The method of claim 8, wherein the amount of delay of the following transaction request is the difference between an expected response date and an actual response date.
